(19) United States
(12) Patent Application Publication
(10) Pub. No.: US 2005/0227164 A1
(43) Pub. Date: Oct. 13, 2005

(54) Near infrared absorbing film and plasma display filter comprising the same

(75) Inventors: Sang-Hyun Park, Daejeon-city (KR); Jung-Doo Kim, Daejeon-city (KR); Hyun-Seok Choi, Seoul (KR); Yeon-Keun Lee, Daejeon-city (KR); In-Seok Hwang, Daejeon-city (KR); Young-Ki Park, Daejeo-city (KR)

Correspondence Address: CANTOR COLBURN, LLP, 55 GRIFFIN ROAD SOUTH, BLOOMFIELD, CT, 06002, US

(73) Assignee: LG CHEM Ltd., Seoul (KR)

(21) Appl. No.: 10/508,221

(22) PCT Filed: Jul. 8, 2004
(86) PCT No.: PCT/KR04/01680

§ 371 Date: Sep. 20, 2004

(30) Foreign Application Priority Data
Nov. 7, 2003 (KR) 10-2003-0047259

(51) Int. Cl. G03C 1/492

(52) U.S. Cl. 430/270.1

(57) ABSTRACT

Disclosed is an infrared absorbing film and a plasma display filter comprising the same cross-linkable binder resin which can be cured by easily radiation or heat and infrared absorbing dye, wherein the film and filter decrease transmittance difference in high temperature and humid and have excellent durability, heat-stability as well as a high transmittance.

### BACKGROUND OF THE INVENTION

(a) Field of the Invention

The present invention relates to a near IR absorbing film and a plasma display filter comprising the same, more particularly, wherein the film and filter decrease a transmittance difference at a high temperature and humidity, and have excellent durability and thermal-stability, as well as high transmittance in the visible region,

(b) Description of the Related Art

Of late, a plasma display panel (PDP) has been gaining focus as a flat panel display for offering a large screen.

The plasma display panel offers the three primary colors by sealing in a discharge gas such as neon (Ne), argon (Ar), xenon (Xe), etc. and emitting light of each of red, green, and blue phosphors by vacuum UV (ultraviolet). However, it is difficult to obtain a clear red color because a neon orange light is emitted at around 590 nm as the excited neon atoms return to the ground state.

To solve this problem, an additional plasma display filter is employed in the plasma display panel, so that the visible rays of red (R), green (G), and blue (B) light pass through the filter, and the orange light around 590 nm and the near IR in the region of 800 to 1000 nm are blocked.

The near IR absorbing film (NIR film) should have good durability at high temperature and humidity, and high absorption in the near IR region of 800 to 1200 nm, especially from 850 to 1000 nm. Preferably, it has visible ray transmittance of at least 60% for visible rays in the region of 430 to 700 nm.

The near IR absorbing film is prepared by mixing a dye and a binder to a solution, and coating it on a transparent plateor casting it as a film.

Suitable binders include polycarbonates, aliphatic polyesters, polyacrylates, melamines, aromatic esters, aliphatic polyolefins, aromatic polyolefins, polyvinyls, polyvinyl alcohols, polymethylmethacrylates, polystyrenes, and their copolymers.

U.S. Pat. No. 5,804,102 and No. 2001-0005278 illustrate suitable dyes, such as ammonium salt, aminium salt, diimmonium salt, quinone salt, phthalocyanine, naphthalocyanine, cyanine, and a metal complex.

U.S. Pat. Nos. 6,117,370 and 6,522,463 disclose a near IR absorbing film prepared by using a polycarbonate resin, a polyacrylate resin, or a polyester resin in which at least 60 mol % of the dicyclic diol components have been copolymerized as a binder resin, mixing a diimmonium or dithiol nickel complex dye with trichloromethane (CHCl₃), and coating it on a transparent substrate. However, the use of chloroform (CHCl₃) is internationally regulated because it is known to destroy the ozone layer. Therefore, an additional system to collect the remaining chloroform should be equipped.

Accordingly, with the recently increasing interest in plasma display panels, development of a near infrared absorbing film having superior durability and stable physical properties including transmittance even at high temperature and humidity is imminent.

### SUMMARY OF THE INVENTION

It is an object of the present invention to provide a near infrared absorbing film experiencing less transmittance change and having superior durability and thermal stability and high transmittance in the visible region at high temperature and humidity.

It is another object of the present invention to provide a plasma display filter comprising the near infrared absorbing film.

### BRIEF DESCRIPTION OF THE DRAWINGS

FIG. 1 is a sectional view showing a conventional plasma display panel.

FIG. 2 is an enlarged sectional view showing a plasma display filter of FIG. 1.

### DETAILED DESCRIPTION OF THE PREFERRED EMBODIMENTS

The present invention provides a near infrared absorbing film, comprising:
(a) a crosslinkable binder resin; and
(b) a near infrared absorbing dye.

The present invention also provides a method of preparation of a near infrared absorbing film, comprising:
mixing a crosslinkable binder resin with a near infrared absorbing dye in a solvent to prepare a coating solution (step 1);
coating the prepared coating solution on a substrate (step 2); and
crosslinking the coating layer formed on the substrate (step 3).

The present invention further provides a plasma display filter comprising the near infrared absorbing film.

“Crosslinkable” as used herein refers to a combining property in which a functional group can be crosslinked by light or heat after decomposing as a radical state.

“Crosslinkable binder resin” as used herein refers to a resin which can be crosslinked by light or heat.

Hereunder a more detailed description of the present invention is given.

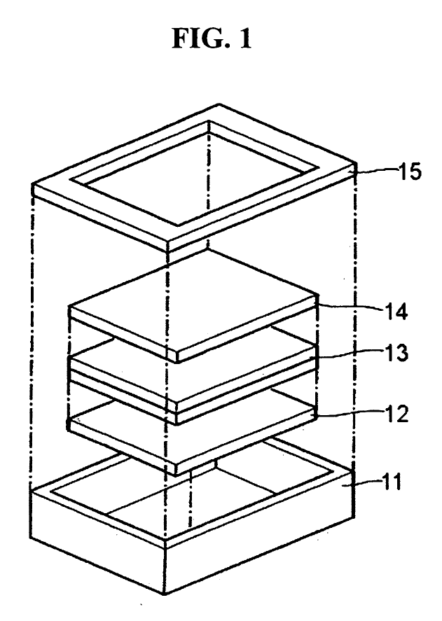

FIG. 1 is a sectional view showing a conventional plasma display panel.

In FIG. 1, a plasma display comprises a panel (11) showing an image; a printed circuit board (12) employing devices for operating the panel, and which is located on the rear of the panel (11); a panel assembly (13) emitting red, blue, and green colors; a plasma display filter (14) positioned on the front of the panel assembly (13); and a case (15) for receiving the panel (11), the printed circuit board (12), the panel assembly (13), and the plasma display filter (14).

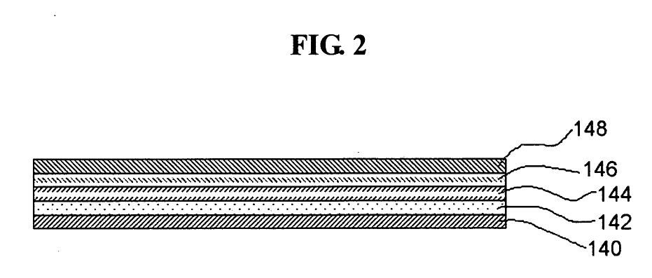

FIG. 2 is an enlarged sectional view showing a plasma display filter (14) of FIG. 1, wherein the plasma display filter (14) has several functional films laminated on a transparent substrate.

In FIG. 2, the plasma display filter (14) comprises an electromagnetic interference layer (142, EMI film), a Neon-cutting layer (144), a near IR resisting layer (146, NIR), and an anti-reflective layer (148, AR) on a transparent plate (140), sequentially. Specifically, the near IR resisting layer (146) has a near IR absorbing film which is made of a mixture of polymeric resin and a near IR absorbing dye coated on a transparent substrate.

The present invention is characterized in that a near IR absorbing film and a filter comprising the same have a lesser transmittance change at high temperature and humidity and superior durability using the crosslinkable binder resin, which can be easily crosslinked by light or heat.

The crosslinkable binder resin of the present invention that may be easily crosslinked by light or heat is comprised of a polyol and an isocyanate compound. A polyol having an OH functional group in a main chain or side chain and that can be crosslinked with the isocyanate compound is used. It is preferred to use polyols which have a number-average molecular weight (Mn) of 100 to 50,000 in consideration of durability and transmittance of a film. If the Mn is below 100, durability of the near IR absorbing film may decrease seriously. Otherwise, transmittance of a near IR absorbing film may be reduced if the Mn exceeds 50,000. Preferred polyols, while not being limited thereto, may be selected from the group of polyether-based polyols, polyester-based polyols, and polyolefin-based polyols, as used in this art.

Suitable isocyanate compounds, while not being limited thereto, may be selected from the group consisting of a methyl diisocyanate compound, (MDI), a diphenylmethanediisocyanate compound, a hexamethylenediisocyanate compound, a trimethylhexamethylenediisocyanate compound, a 2,4-tolunediisocyanate compound, a 1,5-naphthalene diisocyanate compound, an isoporon diisocyanate compound, a cyclohexylmethane diisocyanate compound, a xylene diisocyanate compound, and a tetramethylene xylene diisocyanate compound.

It is preferable that the polyol and isocyanate compound are comprised in the range of 100:1 to 1:100 by weight. If the weight ratio is less than 100:1, a urethane group formed by the polyol and isocyanate compound may not crosslink sufficiently, and it reduces durability of a near IR absorbing film. Otherwise, if it is higher than 1:100, a surface of a near IR absorbing film coated on a substrate may be soiled by unreacted isocyanate compound.

Furthermore, a crosslinking agent can be used for increasing a rate of crosslinking reaction between the polyol and isocyanate compound and for ensuring a sufficient crosslinkable bond, wherein the amount of the crosslinking agent ranges from 0 to 100 weight parts to 100 weight parts of the isocyanate compound.

A suitable crosslinking agent, while not being limited thereto, may be selected from the group consisting of trimethylolpropane, triethanolamine, pentaerythritol, toluene diamine, ethylenediamine, glycerine, oxypropylated ethylene diamine, hexamethylene diamine, m-phenylene diamine, diethanolamine, and triethanolamine.

In comparison with polymers such as polycarbonates, polymethylmethacrylate, and polystyrenes employed on a near IR absorbing film as known in this art, the crosslinked binder resin of the present invention has excellent storage stability at high temperature and humidity and induces a near IR absorbing film to lessen a transmittance difference at high temperature, which leads to improvement of durability.

A suitable near IR absorbing dye of the present invention may be a conventional one as known in this art, and for example is selected from the group of ammonium salt, aminium salt, immonium salt, diimmonium salt, quinone, phthalocyanine, naphthalocyanine, cyanine, and a metal complex.

Preferably, even though each of the immonium salt and diimmonium salt may be used independently because they have enough shielding effect against the near IR range and transmittance in the visible range to be employed in a plasma display filter, it is preferable to use them in combination.

The immonium salt may be N,N,N′N′-tetrakis-(p-di-n-butylaminophenyl)-p-benzoquinone-bis (immonium hexafluoroantimonate, and the diimmonium salt is a diimmonium cation compound as represented in the following Formula 1: 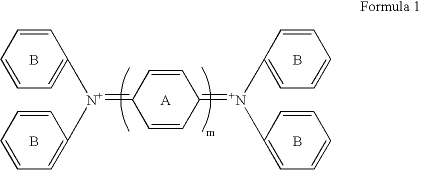
(where
m is an integer of 1 or 2;
the two quaternary nitrogen atoms bonded to the ring A are bonded to four phenyl groups B; and
the phenyl groups B have four substituted amino groups at the 4-positions.)

Preferably, a monovalent or divalent organic acid anion or a monovalent or divalent inorganic acid anion binds with the diimmonium ion.

For the monovalent organic acid anion, one selected from the group consisting of an organic carboxylate ion, such as acetate, lactate, trifluoroacetate, propionate, benzoate, oxalate, succinate, and stearate; an organic sulfonate ion, such as metal sulfonate, toluenesulfonate, naphthalenemonosulfonate, chlorobenzenesulfonate, nitrobenzenesulfonate, dodecylbenzenesulfonate, benzoin sulfonate, ethanesulfonate, and trifluoromethanesulfonate; and an organic borate ion, such as tetraphenylborate and butyltriphenylborate is preferably used.

For the organic acid divalent anion, one selected from the group consisting of naphthalene-1,5-disulfonate, naphthalene-1,6-disulfonate, and naphthalene disulfonate derivatives is preferably used.

For the monovalent inorganic acid anion, one selected from the group consisting of a halogenite such as fluoride, chloride, bromide, and iodide, and thiocyanate, hexafluoroantimonate, perchlorate, periodate, nitrate, tetrafluoroborate, hexafluorophosphate, molybdate, tungstate, titanate, vanadate, phosphate, and borate is preferably used.

Preferably, the diimmonium salt having a diimmonium ion represented by Formula 1 is the compound represented by Formula 2 below: 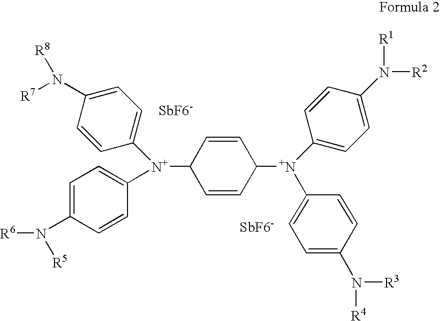
(where
each of R¹ to R⁸ is selected from the group consisting of hydrogen, an alkyl group having 1 to 5 carbon atoms, and an aryl group having 3 to 5 carbon atoms, identically or differently.)

Preferably, each of the R¹ to R⁸ is a butyl group.

As mentioned above, the near IR absorbing dye can absorb to the top of the near IR spectrum, therefore it is used to minimize the transmittance of a near IR film and to increase the transmittance of visible rays. Preferably, the weight proportion of the crosslinkable binder resin and the dye ranges from 5:1 to 50:1. As a result, the near IR absorbing film has a near IR absorbing content of more than 95%, a near IR transmittance of less than 5%, and it maintains over 60% of visible ray transmittance at the wavelength of 380 to 780 nm.

Also, the present invention provides a method of preparation of a near IR absorbing film. Hereinafter, the method of the present invention will be described in more detail.

In a first step, a crosslinkable binder resin is mixed with a near IR absorbing dye in a solvent to prepare a coating solution.

The solvent may be any common organic solvent that can dissolve the crosslinkable binder resin, and is one or a mixture selected from the group consisting of aromatic hydrocarbons, ketones, and methylethylketone (MEK). Among them, methylethylketone (MEK) is preferably used.

In a second step, the coating solution obtained in step 1 is coated on a substrate.

The coating may be performed by any method selected from the group consisting of spray coating, roll coating, bar coating, and spin coating, as is known in this art,

A suitable substrate may be a transparent polymer such as polystyrenes, polyvinylalcohols, and polyacrylates.

In a third step, the coated solution on the substrate in step 2 is crosslinked.

The crosslinking is carried out by radiation of ultraviolet rays or by heating at 40 to 120° C., depending on the crosslinkable binder resin.

It is preferred that the obtained near IR absorbing film according to the present invention has a thickness of 1 to 50 μm as is known in this art, but is not limited thereto.

Referring to FIG. 2, a plasma display filter has a structure of an electromagnetic interference shielding film (EMI film) 142, a neon-cut film 144, a near IR absorbing film (NIR film) 146 of the present invention, and an anti-reflection film (AR film) 148 sequentially stacked on the transparent plate 140.

In addition, the plasma display filter may include a color control film and black screen treatment film, as needed, and the order may be rearranged.

The present invention makes it possible to express the best quality screen, because the plasma display filter of the present invention may be arranged in front of the plasma display panel and block neon light (orange color) of about 590 nm and near IR rays of 800 to 1000 nm, which lowers the resolution of a screen.

Hereinafter, the present invention is described in more detail through Examples and Comparative Examples. However, the following Examples are only for the understanding of the present invention, and the present invention is not limited by the following Examples.

### EXAMPLE 1

In 270 g of methylethylketone (MEK), 2077 g of a polyol having an OH group in a main or side chain as a binder resin (OH value (mg KOH/g 50, MW 2000)), 99.7 g of a hexamethylenediisocyanate compound (HDI) of as an isocyanate compound, and 270 g of trimethylolpropane (TMP) and 99.7 g of ADS 1065A (made by American Dye Source, Inc) as a near IR absorbing dye were dissolved. The obtained coating solution had a solute of 30.4 wt %.

The thus-prepared coating solution was coated on a transparent plate using a bar coater, dried for 2 minutes at 50° C., and crosslinked for 3 minutes at 120° C. to obtain a dye layer having a thickness of 3 μm.

### COMPARATIVE EXAMPLE 1

A dye layer was prepared in the same manner as in Example 1, except that non-crosslinkable polymethylmethacrylate (PMMA) was employed as a binder resin.

### EXPERIMENTAL EXAMPLE 1

A:_High Temperature Condition

The transmittance spectrums were detected after the near IR absorbing films prepared in Example 1 and Comparative Example 1 were left for 500 hours at a temperature between room temperature and 80° C., and the results are shown in Table 1.

TABLE 1

| | | | | | | | | | Infrared ray | |
|---|---|---|---|---|---|---|---|---|---|---|
| | | Visible ray range (nm) | | | | | | | range(nm) | |
| Classification | | 438 | 450 | 490 | 550 | 586 | 628 | 700 | 850 | 950 |
| Example 1 | initial (%) | 69.0 | 67.8 | 62.9 | 78.0 | 80.7 | 79.9 | 64.3 | 4.2 | 3.5 |
| | after (%) | 68.2 | 67.4 | 62.8 | 76.9 | 79.5 | 78.7 | 63.8 | 5.0 | 4.0 |
| | difference(%) | −0.8 | −0.4 | −0.1 | −1.1 | −1.2 | −1.2 | −0.5 | +0.8 | +0.5 |
| Comparative | initial (%) | 78.7 | 79.3 | 81.1 | 84.6 | 84.5 | 83.7 | 75.1 | 39.8 | 14.5 |
| Example 1 | after (%) | 73.6 | 75.4 | 81.7 | 85.4 | 85.3 | 84.5 | 80.5 | 52.8 | 30.4 |
| | difference | −5.1 | −3.9 | +0.6 | +0.8 | +0.8 | +0.8 | +5.4 | +13 | +16.4 |
| | (%) | | | | | | | | | |

B:_High Temperature and Humidity Condition

The transmittance spectrum was detected after the near IR absorbing films prepared in Example 1 and Comparative Example 1 were left for 500 hours at a temperature between room temperature and 60° C., and at 90% humidity, and the results are shown in Table 2.

TABLE 2

| | | | | | | | | | Infrared ray | |
|---|---|---|---|---|---|---|---|---|---|---|
| | | Visible ray range (nm) | | | | | | | range (nm) | |
| Classification | | 438 | 450 | 490 | 550 | 586 | 628 | 700 | 850 | 950 |
| Example 1 | initial (%) | 69.0 | 67.9 | 62.9 | 77.8 | 80.7 | 80.0 | 64.5 | 4.0 | 3.6 |
| | after(%) | 658 | 65.0 | 62.5 | 78.4 | 81.3 | 80.5 | 65.0 | 5.0 | 3.9 |
| | difference | −3.2 | −2.9 | −0.4 | +0.6 | +0.6 | +0.5 | +0.5 | +1.0 | +0.3 |
| | (%) | | | | | | | | | |
| Comparative | initial(%) | 79.9 | 79.5 | 81.3 | 84.8 | 84.7 | 78.4 | 75.4 | 40.4 | 15.1 |
| Example 1 | after(%) | 74.1 | 75.5 | 80.8 | 85.0 | 84.7 | 79.2 | 76.4 | 44.4 | 20.0 |
| | difference | −5.8 | −4.0 | −0.5 | +0.2 | 0 | +0.8 | +1.0 | +4.0 | +4.9 |
| | (%) | | | | | | | | | |

Table 1 and 2 show the initial and after transmittance of a dye layer prepared in Example 1 and Comparative Example 1 at the visible region (400-780 nm, preferably 430-700 nm) at high temperature and high temperature/humidity. As shown in Tables 1 and 2, the tendency of transmittance difference between them is very similar.

However, the near IR absorbing film of Example 1 having a crosslinked binder resin shows less than 1% of transmittance difference and has a superior durability.

On the other hand, the near IR absorbing film of Comparative Example 1 used polymethylmethacrylate (PMMA), which is non-crosslinkable, has a minimum of 4.0% and up to a maximum of 16.1% of transmittance difference between initial and after in the condition of high temperature and high temperature/humidity. In comparison with Comparative Example 1, the near IR film of Example 1 according to this invention has more than 60% transmittance in the visible region, and the transmittance difference both in the near IR region and the visible region in high temperature and high temperature/humidity is decreased. Consequently, by using a crosslinkable binder resin, it is possible to provide a near IR absorbing film having superior durability.

1. A near infrared absorbing film, comprising:
(a) a crosslinkable binder resin, and
(b) a near infrared absorbing dye.

2. The near infrared absorbing film according to claim 1, wherein the (a) crosslinkable binder resin is a crosslinked resin with a polyol and an isocyanate compound.

3. The near infrared absorbing film according to claim 2, wherein the polyol is one compound selected from the group consisting of polyether polyols, polyester polyols, and polyolefin polyols.

4. The near infrared absorbing film according to claim 2, wherein the number-average molecular weight (Mn) of the polyol ranges from 100 to 50,000.

5. The near infrared absorbing film according to claim 2, wherein the isocyanate compound is one compound selected from the group consisting of a methyl diisocyanate compound (MDI), a diphenylmethanediisocyanate compound, a hexamethylenediisocyanate compound, a trimethylhexamethylenediisocyanate compound, a 2,4-tolunediisocyanate compound, a 1,5-naphthalene diisocyanate compound, an isoporon diisocyanate compound, a cyclohexylmethane diisocyanate compound, a xylene diisocyanate compound, and a tetramethylene xylene diisocyanate compound.

6. The near infrared absorbing film according to claim 2, wherein the polyol and isocyanate compound are crosslinked in the range of from 100:1 to 1:100 by weight.

7. The near infrared absorbing film according to claim 1, wherein the crosslinkable binder resin further comprises a crosslinking agent.

8. The near infrared absorbing film according to claim 7, wherein the crosslinking agent is contained in an amount of 0 to 100 weight parts to 100 weight parts of the isocyanate compound.

9. The near infrared absorbing film according to claim 7, wherein the crosslinking agent is one compound selected from the group consisting of trimethylolpropane, triethanolamine, pentaerythritol, toluene diamine, ethylenediamine, glycerine, oxypropylated ethylene diamine, hexamethylene diamine, m-phenylene diamine, diethanolamine, and triethanolamine.

10. The near infrared absorbing film according to claim 1, wherein the b) the near infrared absorbing dye is one compound selected from the group consisting of ammonium salt, aminium salt, immonium salt, diimmonium salt, quinine, phthalocyanine, cyanine, and a metal complex.

11. The near infrared absorbing film according to claim 9, wherein the immonium salt is N,N,N′N′-tetrakis-(p-di-n-butylaminophenyl)-p-benzoquinone-bis(immonium hexafluoroantimonate.

12. The near infrared absorbing film according to claim 9, wherein the immonium salt is represented by Chemical Formula 1: 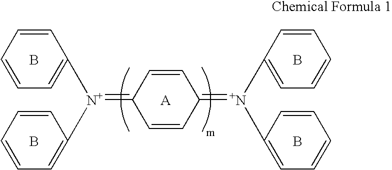
(where
m is an integer of 1 or 2;
the two quaternary nitrogen atoms bonded to the ring A are bonded to four phenyl groups B; and
the phenyl groups B have four substituted amino groups at the 4-positions.)

13. The near infrared absorbing film according to claim 1, wherein the near infrared absorbing film comprises (a) a crosslinkable binder resin and (b) a near infrared absorbing dye in an amount of 5:1 to 50:1 by weight.

14. A method of preparation of a near infrared absorbing film, comprising:
mixing a crosslinkable binder resin with a near infrared absorbing dye in a solvent to prepare a coating solution (step 1);
coating the prepared coating solution on a substrate (step 2); and
crosslinking the coating layer formed on the substrate (step 3).

15. The method of preparation of a near infrared absorbing film according to claim 14, wherein the crosslinking of step 3 carried out at a temperature of 40 to 120° C., or is irradiated by ultraviolet rays.

16. A plasma display filter comprising the infrared absorbing film of claim 1.
